(19) United States
(12) Patent Application Publication
(10) Pub. No.: US 2016/0327187 A1
(43) Pub. Date: Nov. 10, 2016

(54) Sanitary Utility Hanger System

(71) Applicant: Madison Sheet Metal, LLC, Madison, WI (US)

(72) Inventor: Matthew E. Brown, (US)

(73) Assignee: Madison Sheet Metal, LLC, Madison, WI (US)

(21) Appl. No.: 15/146,651

(22) Filed: May 4, 2016

Related U.S. Application Data
(60) Provisional application No. 62/158,278, filed on May 7, 2015.

(51) Int. Cl. F16L 3/22; F16L 3/133

(52) U.S. Cl. CPC F16L 3/221; F16L 3/133

(57) ABSTRACT

A utility hanger system for the food, beverage, and pharmaceutical industries has a main hanger member extending in an axial direction, which has an axially extending semicylindrical central segment of a first radius, the central segment terminating in first and second wings on opposite sides of the central segment. A slot extends axially along the main hanger member and is positioned between two rod holes. Rods extend through the rod holes to an overhead support member and are fixed to the main hanger member by nuts. Pipes and conduits are gripped within standoffs which space the pipes from the main hanger member with a hexagonal member which is bolted within the main hanger member slot. The pipes and conduits can be supported above or below the main hanger member.

### CROSS REFERENCES TO RELATED APPLICATIONS

The present application claims the benefit of priority of U.S. provisional App. No. 62/158,278, filed May 7, 2015, the disclosure of which is incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The present invention relates to arrangements for supporting utility pipes and conduits in general, and in particular those for use within food or drug processing facilities where high levels of hygiene must be maintained.

Production facilities which produce products for human consumption such as food, beverages, and pharmaceuticals, must be maintained in a sanitary condition to avoid contamination of the products which might be harmful to consumers. Just as with any manufacturing site, these facilities include conventional conduits and piping for delivering water, electricity and ventilation. Moreover, there are frequently specialized conduits for transporting process liquids, cleaning fluids, and other production elements. To provide for frequent and expeditious service of these conduits, they must be exposed within the facility in a fashion which provides ready access. Yet this accessibility means that organic materials from the production processes can reach the conduits and can settle there. Any crevasse or tight area, flat surface, exposed threads or cavities can serve as a harborage point for dust, product and microorganisms to live. Effective hygiene in such environments calls for periodic wash downs of the facility, including the hangers and conduits. Harborage points in particular must be attended to, which can be a very time consuming and hand-labor-intensive procedure.

Thus utility hangers in wash down environments will often be of welded construction which avoids threaded rods and fasteners and eliminates most harborage points. However, such custom fabrication is costly and can take a long time to construct. Other hangers for these environments must be custom ordered to length, which takes extra time and money to pre-layout all the hangers involved. Other hangers utilize a u-bolt and nut system to fasten pipes and tubes directly to the hanger. However, u-bolt and nut systems can present harborage points which are difficult to clean. Other systems use angled cross members supported by threaded rods, but these require specialized and costly fasteners.

Other hangers can only be fabricated and installed by specialty personnel that know how to fabricate and weld. Some hangers are made from pipe and are welded into what is called “trapeze hangers.” These pipe hangers create hollow cavities inside of the hanger that will eventually provide volumes where microorganisms can live.

What is needed is a pipe hanger system which requires a minimum of custom parts, can be assembled without welding in the field, and which facilitates speedy and effective sanitation.

### SUMMARY OF THE INVENTION

The invention is a sanitary utility hanger system that replaces the conventional UNISTRUT and custom made hangers in the food and beverage industry. The hanger system may support pipes, sanitary tubing, electrical conduits, fans, heaters and anything that can be mounted to a stand-off. The elements of the hanger system working together comprise an effective sanitary hanger system. The cooperation of the system elements facilitates ready installation and reuse of parts. The main hanger has a unit hole and slot design which allows the main hanger to be simply cut to the needed length and installed using solid round rod which is field threaded at the ends. The rods extend from the roof or ceiling to the main hanger unit. The main hanger supports the various utility standoffs. Additionally, the main hanger can be used to support other equipment that hangs off the ceiling. The standoffs and connected pipes and conduits can extend above or below the main hanger. The main hanger is preferably a stainless steel section with a semicylindrical central segment which is terminated by first and second planar wings on opposite sides of the central segment. Where greater load carrying capacity is required, e.g., stiffness, the main hangers may be fabricated to have wings of greater length.

Wall bracket elements bolt onto a wall and have the same hole and slot design as the main hanger and supports the utility hangers in the same fashion as the main hangers. The wall bracket is used when the ceiling is inaccessible or unavailable. It is also used when there is an issue of using too much wall space.

Horizontal sanitary wall elements are fastened to walls for supporting utilities that are installed in a vertical manner parallel to the wall. These wall elements hold the utilities plumb right and left.

Sanitary stand off embodiments support, but are not limited to, utilities off the main hanger, wall gussets, vertical ceiling supports, horizontal wall supports and directly to walls, ceilings and machinery.

Pipe saddle clamps support pipes that are insulated. They support utilities in the horizontal position. In the vertical position the pipe saddle clamps hold the pipe vertically plumb. This design creates no penetrations through the jacketing of the insulation.

Vertical ceiling brackets are attached to the roof or ceiling by a bolting plate welded on one end of the bracket, and are arranged to hang in a vertical position and support the utilities from the side, which are in the horizontal position.

Electrical disconnect elements are designed to support electrical disconnect boxes in a manner of standing them off of items with weldments or bolted/bonded/attached stand-offs.

Further objects, features and advantages of the invention will be apparent from the following detailed description when taken in conjunction with the accompanying drawings.

### BRIEF DESCRIPTION OF THE DRAWINGS

FIG. 1 is an exploded axonometric view of the hanger system of this invention.

FIG. 2 is a perspective view of the main hanger of the system of FIG. 1.

FIG. 3 is a cross-sectional view of the main hanger of FIG. 2 taken along section line 3-3, further showing an attached stand-off.

FIG. 4 is a perspective view of a horizontal sanitary wall bracket, partially broken away.

FIG. 5 is a perspective view of a sanitary stand-off hanger for tube.

FIG. 6 is a perspective view of a sanitary pipe saddle clamp for insulated pipe.

FIG. 7 is a schematic view of a forming arrangement for the main hanger of FIG. 2.

FIG. 8 is a perspective view of a horizontal wall support.

FIG. 9 is a perspective view of a vertical ceiling bracket.

FIG. 10 is a perspective view of a bracket for mounting an electrical disconnect shown in phantom view.

### DESCRIPTION OF THE PREFERRED EMBODIMENTS

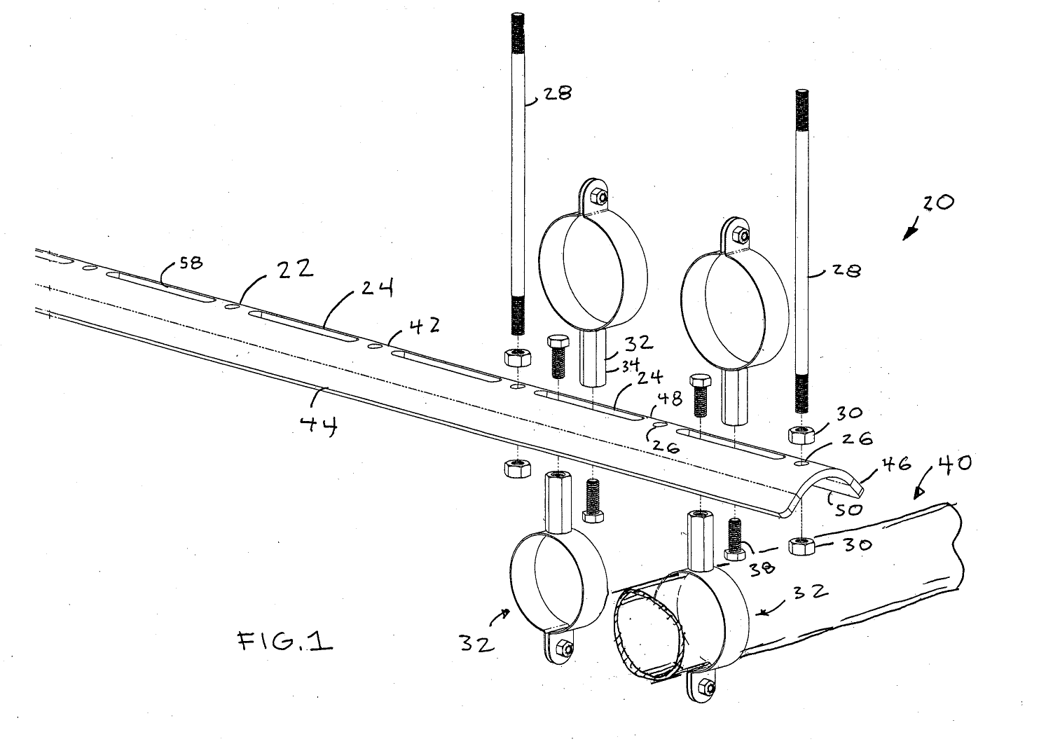

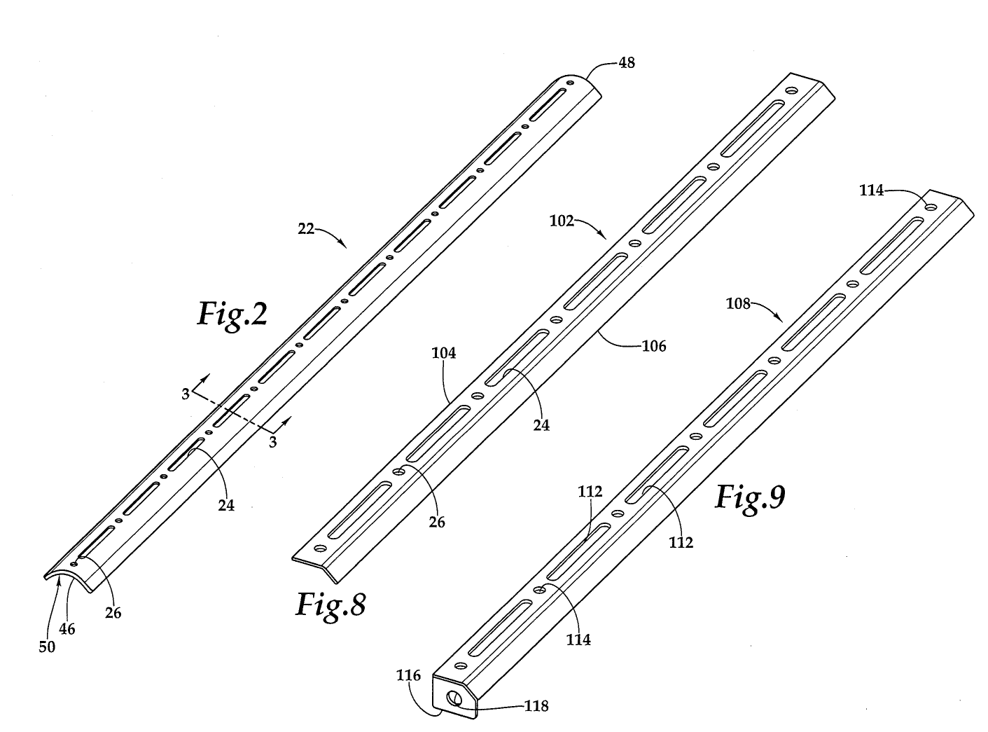

Referring more particularly to FIGS. 1-10, wherein like numbers refer to similar parts, a sanitary hanger system 20 is shown in FIG. 1. The system includes a main hanger 22 which has an array of axial slots 24 positioned between mounting holes 26 aligned on the axis. The slots 24 may be about ½ inch wide, with ½ inch radius rounded ends. The slots are about four inches between the centers of the rounded slot ends, and the mounting holes are about ½ inch in diameter with the centers between mounting holes being spaced about six inches apart. Conventional round rod 28 is threaded on its two ends, allowing it to be bolted to the ceiling on one end, and fixed to the main hanger 22 by conventional nuts 30 on both sides of the hanger. The main hangers 22 may be provided in 68 inch lengths for optimal usage with conventional bar joist centerlines. The distance between the outermost mounting holes 26 is 66 inches which corresponds to standard joist spacing. The main hangers 22 may be then cut in the field as needed to accommodate specific spacing requirements. The main hanger 22 may support a variety of utility pipes, sanitary tubes and electrical conduits, and other elements. Stand-off clamps 32 each have a hexagonal stand-off member 34 with an internal threaded cavity 36 shown in FIG. 3. A bolt 38 extends through one of the slots 24 into the internal threaded cavity 36 to fix each stand-off clamp 32 and its associated pipe or conduit 40 to the main hanger 22. The inserted bolt is sealed with an adhesive such as food grade Loc-Tite brand adhesive.

As shown in FIG. 3, the main hanger 22 is a metal section, preferably formed of 11 gauge and ¼″ thick stainless steel type 304 or 316. The profile of the main hanger 22 has a semicylindrical central segment 42 of internal radius R. The radiused central segment 42 is terminated by first and second planar wings 44, 46 on opposite sides of the central segment. The radius R may be about one and ¼ inch to about 1 and a ½ inches, preferably about 1 and ½ inches, with the angle between the two wings being more than about 60 degrees and less than about 110 degrees and preferably about 90 degrees. The length of each wing 44, 46 may be about 0.75 inches. Moreover, where greater load carrying capacity is required, the main hanger may be fabricated to have wings of greater length. The angle between the two wings is less than 180 degrees so that the upper surface 48 of the main hanger will tend to shed liquid and resist build-up of dust, and is preferably about 90 degrees or greater, to facilitate access to the lower surface 50 of the main hanger.

The profile of the main hanger 22 may be formed in a large press brake or preferably formed in a larger press brake with special coin and stamping dies as illustrated in FIG. 7. The press punch 47 has a surface with a portion of the radius R, and the opposing tool 52 has a cavity 54 with walls 56 angled at 90 degrees which control the shape of the part as it extends from the radius to the planar wall segments. The same die set may be used for a main hanger 22 with the same central radiused segment with wings of different dimensions.

After the profile of the main hanger is formed, the slots 24 and mounting holes 26 are preferably cut with a water jet, although they may be laser cut or formed in some other fashion. Thus the slots 24 have parallel walls 58.

The large central radius design of the main hanger 22 offers several benefits. First, the stand-off clamps may support utilities extending upwardly from the upper surface 48, or extending downwardly from the lower surface 50, allowing the main hanger to be utilized to maximum efficiency. Sanitary tubing and electrical conduit, being more lightweight, will generally be supported either above or below the main hanger. Heavier pipe, such as steam tubing, will generally be supported above the main hanger. The large radius of the main hanger means that no special fasteners are needed to support the main hanger on the rods 28. The large radius of the main hanger 22 also creates a uniform surface which facilitates cleaning, and ample clearance to access the underside of the main hanger when there are stand-off clamps bolted below. The large radius and wings of the main hanger allow water and debris to run off the hanger easily. Moreover, the semicylindrical central segment defines an arch for added strength, i.e., stiffness to prevent buckling. This main hanger has a hole and slot design allowing different hangers to bolt to the main hanger. This main hanger permits directly changing out UNISTRUT® and other hanger systems.

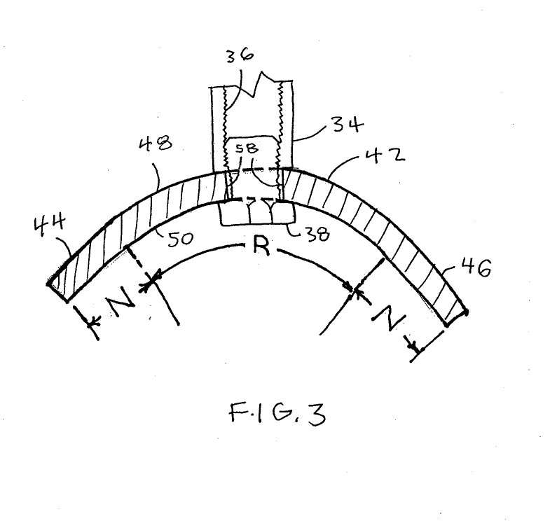

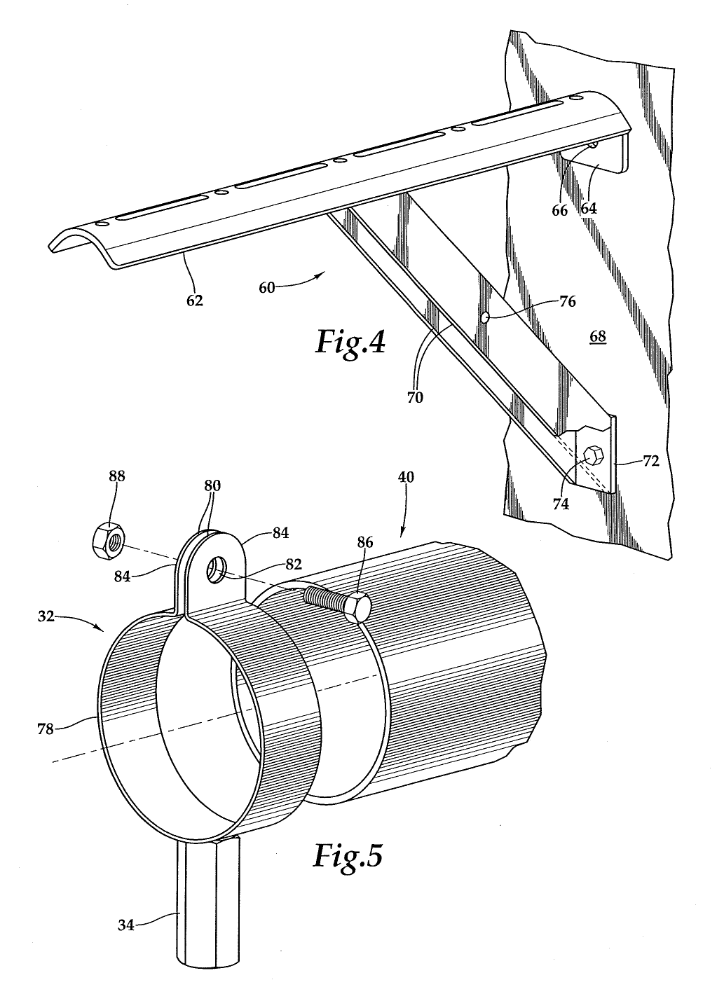

As shown in FIG. 4, a horizontal wall bracket 60 has an upper formed member 62 of the same profile and slot and hole construction as the main hanger 22. The horizontal wall bracket 60 may support utility pipes, sanitary tubes and electrical conduits and other elements in a sanitary fashion. The utilities are in the horizontal position when supported from the wall. The upper member 62 has the same radius, hole and slot pattern as the main hanger. The large radius is the same allowing the stand-off brackets to support utilities from the top and from the underside of the upper member 62. The upper member 62 has welded to one end an upper bolting plate 64, with a central hole 66 for attachment to a wall 68. Two bracket plates 70 are welded to a midpoint of the upper member 62 and extend downwardly at about a 45 degree angle. The bracket plates 70 are terminated by a welded lower bolting plate 72 which also has a central hole which receives a bolt 74 for securing the lower bolting plate 72 to the wall 68. A stiffening round rod 76 is welded in between the two bracket plates 70. The bracket plates 70 are parallel to one another with the space between open except for the lower bolting plate and the rod 76. This horizontal wall bracket 60 is made out of 11 gauge stainless steel type 304 or 316.

The stand-off clamps 32, as shown in FIG. 5, support utility pipes, or other cylindrical conduits off the main hanger 22. It should be noted that other elements may be mounted to the main hanger, with or without a clamp, even in a single use application where a nut is threaded onto a stud, round rod or bolt. The stand-off clamp 32 has a generally cylindrical single strip 78 that is welded to the threaded rod coupling stand-off member 34. The member 34 has six sides and may be fabricated of stainless steel type 304 or 316. The six-sided member 34 may thus be engaged by a wrench to permit the stand-off clamp 32 to be secured to the main hanger 22. The strip 78 has two tabs 80 each with a punched central bolt hole 82. The tabs 80 have a rounded perimeter 84 which reduces sharp edges and facilitates cleaning. The strip 78 is formed around a die to allow for proper pipe diameter sizing. The central bolt holes 82 receive a bolt 86 which is secured with a lock nut 88 which is tightened to hold the strip to the pipe 40. The strips are made of 14, 18 and 20 gauge stainless steel type 304 or 316. The stand-off clamps 32 stands the utilities off of, but not limited to, main hangers, walls, ceilings and machines for sanitation ease of cleaning. The stand-off clamps 32 are preferably gas tungsten arc welded and polished to a food grade surface finish.

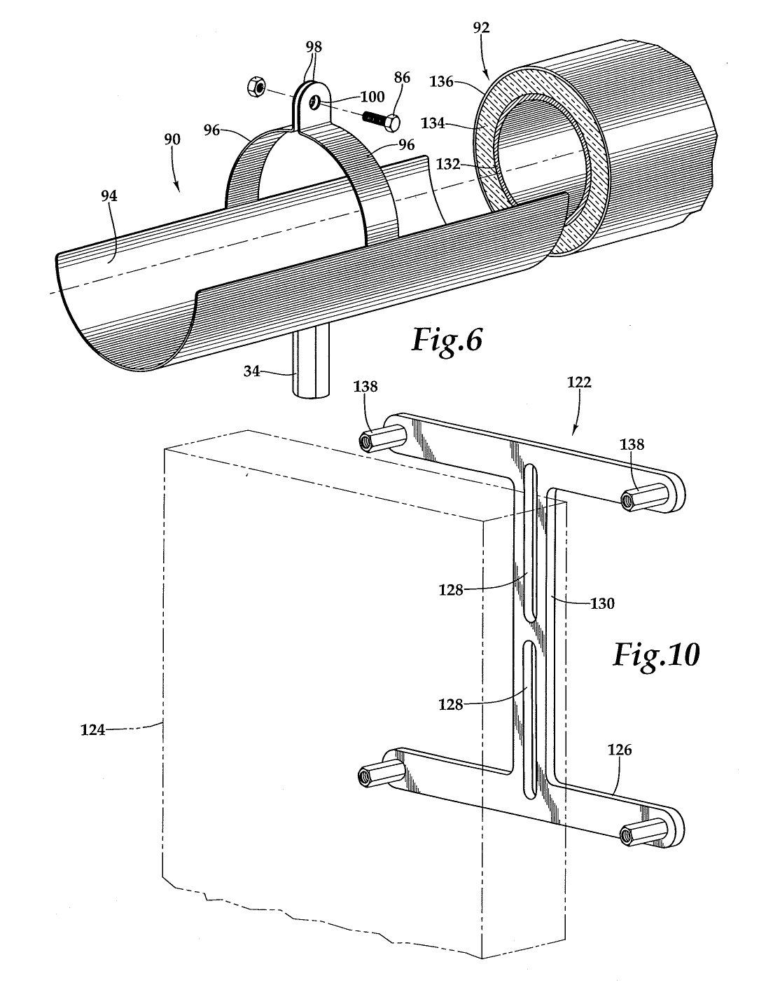

A saddle stand-off clamp 90, shown in FIG. 6, mounts insulated pipe 92 to the main hanger 22. The saddle stand-off clamp 90 supports an insulated pipe off a main hanger of the system in a horizontal or vertical position, without penetrating the outside jacket of the pipe insulation. A conventional insulated pipe 92 has an internal pipe 132 surrounded by insulation 134 and retained within a glued plastic jacket 136. The saddle stand-off clamp 90 has a rolled sheet metal base 94 and two metal strips 96 which define a portion of a cylinder. Each strip has a terminal tab 98 with a punched central hole 100. A bolt 86 passes through the tab holes 100, and receives a lock nut 88 by which the strips 96 can be tightened around the pipe insulated jacket. An internally threaded hexagonal rod coupling stand-off member 34 is welded to the underside of the base 94. It is welded centered in both directions to the sheet metal base 94. This coupling attaches the saddle stand-off clamp 90 to the main hanger 22 and supports the pipe and insulation. The element 90 can also be used on the horizontal wall bracket described below and may hold the insulated pipe in the vertical position plumb right and left. The saddle stand-off clamp 90 may be provided with additional partial cylindrical strips and fasteners, not shown, to provide additional support for the engaged insulated pipe. The rolled sheet metal base 94 and strips 96 are preferably formed of 18 and 20 gauge stainless steel type 304 or 316.

The system may include additional forms of hanger members. For example, a horizontal wall bracket 102 is shown in FIG. 8. The horizontal wall bracket 102 is used to support utilities that are in the vertical position that run down parallel to the wall, and supports the utilities plumb right and left. The embodiment has the same hole 26 and slot 24 design as the main hanger 22 in its bolting segment 104. This allows the utilities to be bolted in various layouts on the bolting segment 104. The hole and slot design in the bolting segment allows the horizontal wall bracket 102 to be cut to length for various installation situations. The horizontal wall bracket 102 uses the hole and slot design to support the bracket with round rods or stand-offs off the walls or machinery that the utilities are servicing. The horizontal wall bracket 102 is made out of 11 gauge stainless steel type 304 or 316 and is cut with a water jet. A side segment 106 extends from the bolting segment 104, bent at about 135 degrees. The bend may be added in a press brake for rigidity of the part.

A vertical ceiling bracket 108, shown in FIG. 9 is configured to hang in a vertical position from the roof or ceiling. The bracket 108 has a bolting segment 110 with an arrangement of slots 112 and mounting holes 114 similar to that on the main hanger 22. The stand-off clamps 32, 90, attach to the bolting segment 110 and to the utilities that may run horizontally stacked over one another. A bolt plate 116 with a central hole 118 is welded to one end of the bolting segment 110 such that the bracket 108 may be fastened to the roof or ceiling. A bent segment 120 extends from the bolting segment 110 for added rigidity. The bracket 108 is preferably formed of 11 gauge stainless steel type 304 or 316.

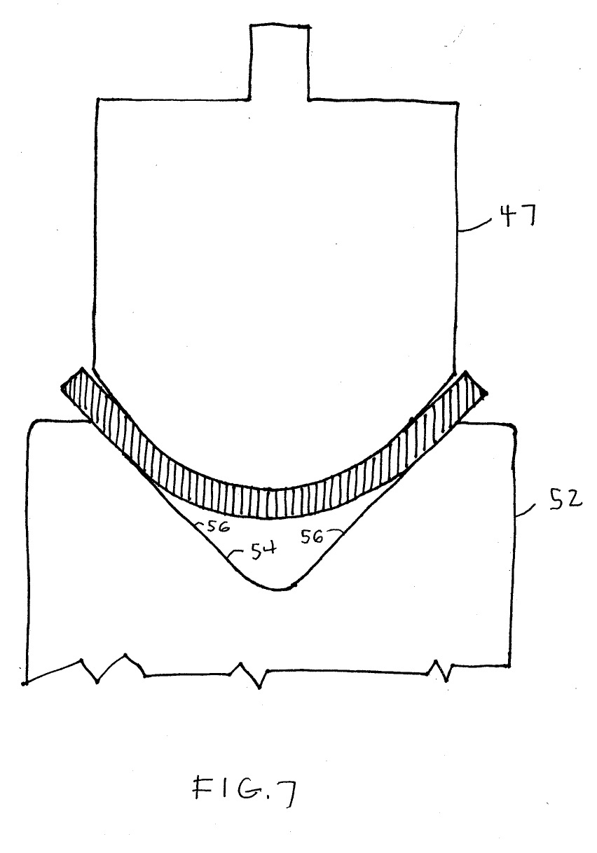

An electrical disconnect bracket 122, shown in FIG. 10, serves to standoff electrical disconnects, for example a Hubbell® electrical disconnect box 124, for sanitary ease of cleaning and installation. The bracket 122 replaces the need to custom build from bar stock and stand-off parts to fabricate on the job site. The generally H-shaped frame 126 of the bracket 122 has two coaxial slots 128 extending along the middle web 130 to receive threaded rod couplings or stand-off rods for fastening the bracket to an appropriate location. Internally threaded standoffs 138 are mounted to the four corners of the frame 126. The bracket 122 may have a piece of metal welded to the edge of it in any direction off the top, right side, left side, or bottom of the frame 126, so as to weld to available neighboring structure. The shape is designed, but not limited to, support a specific electrical disconnect for the food and beverage industry. This frame 126 is water jet cut out of one solid piece of material and may be constructed out of 11 gauge and threaded rod couplings all type 304 or 316.

It should be noted that U-bolts could be used to mount pipes and conduits directly to the main hanger, although lacking the advantages of the stand-off clamps disclosed in ease of cleaning.

It is understood that the invention is not limited to the particular construction and arrangement of parts herein illustrated and described, but embraces all such modified forms thereof as come within the scope of the following claims.

I claim:

1. A support assembly for conduits comprising:
a main hanger member extending in an axial direction, the main hanger having an axially extending semicylindrical central segment of a first radius, the central segment terminating in first and second wings on opposite sides of the central segment;
portions of the main hanger member which define at least one axially extending slot;
portions of the main hanger member defining at least two rod holes, aligned on either end of and spaced from the at least one axially extending slot;
two support rods, one extending through each of the at least two rod holes, the support rods being connected to the main hanger member by fasteners;
a standoff member having an interior threaded cavity which engages against and extends away from the main hanger member, and which has an engagement member spaced away from the main hanger member for engagement with a pipe or conduit; and
a fastener which extends through the at least one axially extending slot of the main hanger member to be received within the interior threaded cavity of the standoff member to thereby secure the standoff member to the main hanger member.
